(19) United States
(12) Patent Application Publication
(10) Pub. No.: US 2026/0339626 A1
(43) Pub. Date: Oct. 29, 2026

(54) INFORMATION PROCESSING DEVICE AND INFORMATION PROCESSING METHOD

(71) Applicant: Kioxia Corporation, Tokyo (JP)

(72) Inventors: Yuma YOSHINAGA, Kawasaki Kanagawa (JP); Osamu TORII, Shibuya Tokyo (JP); Shinichiro MANABE, Yokohama Kanagawa (JP); Satoru YOKOTA, Yokohama Kanagawa (JP); Masahiro HAYASHI, Taito Tokyo (JP)

(73) Assignee: Kioxia Corporation, Tokyo (JP)

(21) Appl. No.: 19/566,386

(22) Filed: Mar. 13, 2026

(30) Foreign Application Priority Data
Apr. 24, 2025 (JP) 2025-072403

(51) Int. Cl. G06F 8/35; G06F 16/3329

(52) U.S. Cl. CPC G06F 8/35; G06F 16/33295

(57) ABSTRACT

An information processing device comprising processing circuitry inputs analysis target data and a request sentence, generates a prompt based on the analysis target data and the request sentence, generates a code based on the prompt, executes the generated code, evaluates an execution result to generate a label, stores in a first storage, execution result information including the label and an error message generated when executing the code, stores in a second storage, prompt related information including the generated prompt, the executed code, and the error message, corrects the generated prompt based on the execution result information and the prompt related information, evaluates the executed code based on an evaluation result of the execution result, and outputs at least one of the evaluation result of the execution result or an evaluation result of the executed code, wherein the processing circuitry regenerates a code based on the corrected prompt.

### CROSS REFERENCE TO RELATED APPLICATIONS

This application is based upon and claims the benefit of priority from the prior Japanese Patent Application No. 2025-072403, filed on Apr. 24, 2025, the entire contents of which are incorporated herein by reference.

### FIELD

An embodiment of the present invention relates to an information processing device and an information processing method.

### BACKGROUND

There has been proposed a technique of automatically generating a code for a specific program language using a large language model (LLM) without bothering a human’s hand, and feeding back an execution result of the generated code to repeatedly correct the code.

However, the existing techniques only consider correcting a newly generated code on the basis of an immediately preceding execution result of the code, and do not utilize execution results of a plurality of codes generated in the past. As a result, there is a possibility that an execution result similar to that of a code generated in the past is generated many times, and an optimal code cannot be efficiently generated.

### BRIEF DESCRIPTION OF THE DRAWINGS

FIG. 1 is a block diagram illustrating a schematic configuration of an information processing device according to an embodiment;

FIG. 2 is a flowchart illustrating processing operation of the information processing device according to the embodiment;

FIG. 3 is a detailed flowchart of processing operation of step S5 in FIG. 2;

FIG. 4 is a diagram illustrating an example of a table stored in an execution result DB;

FIG. 5 is a diagram illustrating an example of a prompt corrected by a prompt correction unit;

FIG. 6 is a diagram illustrating update contents of the table in a case where a code is regenerated on the basis of the corrected prompt of FIG. 5;

FIG. 7 is a flowchart illustrating processing operation of a user evaluation unit;

FIG. 8A is a diagram illustrating an example in which prompt related information is stored in a prompt storage unit in an overwrite manner;

FIG. 8B is a diagram illustrating an example in which the prompt related information is stored in the prompt storage unit in a history holding manner; and

FIG. 9 is a diagram illustrating an example of prompt related information stored in the prompt storage unit, an error message output from an execution result evaluation unit, and a prompt corrected by the prompt correction unit when a code generation unit uses LLM.

### DETAILED DESCRIPTION

In general, according to the embodiment, an information processing device comprising processing circuitry configured to:
input analysis target data and a request sentence;
generate a prompt based on the analysis target data and the request sentence;
generate a code based on the prompt;
execute the generated code;
evaluate an execution result of the generated code to generate a label;
store in a first storage, execution result information including the label and an error message generated when executing the generated code;
store in a second storage, prompt related information including the generated prompt, the executed code, and the error message;
correct the generated prompt based on the execution result information and the prompt related information;
evaluate the executed code based on an evaluation result of the execution result; and
output at least one of the evaluation result of the execution result or an evaluation result of the executed code, wherein
the processing circuitry is configured to regenerate a code based on the corrected prompt.

In the following, an embodiment of an information processing device and an information processing method will be described with reference to the drawings. Although main components of the information processing device will be mainly described below, the information processing device may have components and functions that are not illustrated or described. The following description does not exclude components and functions that are not illustrated or described.

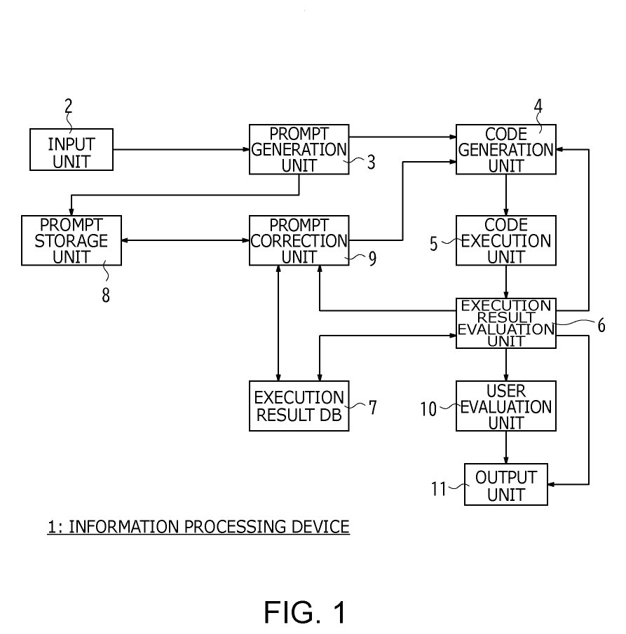

FIG. 1 is a block diagram illustrating a schematic configuration of an information processing device 1 according to an embodiment. The information processing device 1 according to the embodiment illustrated in FIG. 1 includes an input unit 2, a prompt generation unit 3, a code generation unit 4, a code execution unit 5, an execution result evaluation unit 6, an execution result database (hereinafter, an execution result DB, a first storage unit) 7, a prompt storage unit (a second storage unit) 8, a prompt correction unit 9, a user evaluation unit 10, and an output unit 11.

The input unit 2 inputs analysis target data and a request sentence. The analysis target data includes, for example, an explanatory variable and an objective variable. The analysis target data includes, for example, a file path and a file name for storing each of the explanatory variable and the objective variable. The file path is information indicating a storage location of a file. The request sentence is a sentence specifically describing what kind of code is to be generated. Although a format of the request sentence is not limited, it is, for example, a format of a sentence for use in daily conversation.

The prompt generation unit 3 generates a prompt on the basis of the analysis target data and the request sentence. The prompt is an instruction sentence indicating what kind of code is to be generated. For example, the prompt includes a type of a machine learning model (hereinafter, it is simply referred to as a model) that infers a code, input data given to the model, a file path and a file name of the input data, and the like. The prompt may also include an error message generated when executing a previously generated code. The model is, for example, a learned LLM.

The code generation unit 4 generates a code on the basis of a prompt generated by the prompt generation unit 3. The code generation unit 4 generates a code of a program language specified in advance. The program language may be always fixed or may be arbitrarily selected by a user. When generating a code for the first time, the code generation unit 4 generates the code using the prompt generated by the prompt generation unit 3. When regenerating a code, the code generation unit 4 generates the code on the basis of a prompt corrected by the prompt correction unit 9. For example, the code generation unit 4 inputs a prompt to a learned LLM, performs inference processing in the LLM, and outputs a code inferred in the LLM.

When it is determined that a probability that automatic correction is possible is lower than a predetermined reference value on the basis of a label included in execution result information in the execution result evaluation unit 6 to be described later, the code generation unit 4 repeats the regeneration of a code a predetermined number of times until the code is successfully executed or the probability that the automatic correction is possible becomes higher than the predetermined reference value. Alternatively, the code generation unit 4 repeats the regeneration of a code the predetermined number of times regardless of whether or not the probability that the automatic correction of the code is possible is high and regardless of whether or not the code is successfully executed.

The code execution unit 5 executes a code generated by the code generation unit 4. The code execution unit 5 outputs information indicating whether the code has been successfully executed or failed. In addition, when an error occurs due to the execution of the code, the code execution unit 5 outputs an error message indicating contents of the error, a location of the error occurring in the code, and the like. There may be a plurality of error messages with different error contents. In the present specification, the information output by the code execution unit 5 is collectively referred to as a code execution result.

The execution result evaluation unit 6 evaluates an execution result of the code execution unit 5 to generate a label. The label is generated, for example, for each error message. More specifically, the labels include, for example, a label indicating an execution success and a label indicating an execution failure. The type of label is arbitrary. The execution result evaluation unit 6 generates a label according to a probability that automatic correction of a code is possible on the basis of contents of the error message.

When the code execution unit 5 fails to execute a code, the execution result evaluation unit 6 according to the present embodiment may generate a label with a large automatic correctable probability (hereinafter, a first label) indicating that a probability that automatic correction is possible is higher than the predetermined reference value, or a label with a small automatic correctable probability (hereinafter, a second label) indicating that the probability that the automatic correction is possible is lower than the predetermined reference value.

The execution result DB 7 stores the execution result information including a label and an error message. The information processing device 1 according to the present embodiment may repeatedly regenerate a code even when the code execution unit 5 has succeeded in executing the code. This is to further improve quality of the code.

The execution result information stored in the execution result DB 7 may include the number of times of execution of the code and the number of times of successful correction. For example, the execution result DB 7 has a table in which a type name of an error message, a label, the number of times of execution of a code, and the number of times of successful correction of the code after correction are associated with each other. In this case, the execution result evaluation unit 6 updates the label on the basis of the table stored in the execution result DB 7. Alternatively, the execution result DB 7 stores unique information that affects the quality of the code. In this case, the prompt correction unit 9 corrects a prompt to further improve the quality of the code on the basis of the unique information. The unique information includes, for example, at least one of user's preference and coding rules.

The execution result DB 7 has a table for each type of LLM for use by the code generation unit 4 to generate a code or for each program language with which the code generation unit 4 generates a code.

The execution result evaluation unit 6 may update a label on the basis of the table stored in the execution result DB 7. More specifically, the execution result evaluation unit 6 may update the label on the basis of a ratio of the number of times of execution and the number of times of successful correction in the table stored in the execution result DB 7.

The prompt storage unit 8 stores prompt related information including the prompt generated by the prompt generation unit 3, the code executed by the code execution unit 5, and the error message generated at the time of execution of the code. As will be described later, the prompt storage unit 8 may store history information of a prompt, a code, and an error message for each code generated in the past, or may overwrite and store only a prompt, a code, and an error message for the latest code.

The prompt correction unit 9 corrects the prompt generated by the prompt generation unit 3 on the basis of the execution result information and the prompt related information. For example, the prompt correction unit 9 corrects the prompt so as to include an instruction sentence instructing to resolve an error message generated at the time of execution of the code execution unit 5. When it is determined that a probability that automatic correction is possible is lower than the predetermined reference value on the basis of the label included in the execution result information, the prompt correction unit 9 generates a new prompt without referring to the prompt included in the prompt related information. More specifically, when the execution result evaluation unit 6 generates the first label as the large automatic correctable probability, the prompt correction unit 9 corrects the prompt on the basis of the prompt and the error message stored in the prompt storage unit 8, and when the execution result evaluation unit 6 generates the second label as the small automatic correctable probability, the prompt correction unit 9 regenerates a prompt without diverting the prompt stored in the prompt storage unit 8.

The user evaluation unit 10 lastly evaluates the code executed by the code execution unit 5 on the basis of an evaluation result of the execution result evaluation unit 6. For example, in a case where it is determined that the probability that the automatic correction is possible is lower than the predetermined reference value on the basis of the label included in the execution result information even when the code generation unit 4 repeats the regeneration of the code the predetermined number of times, or in a case where the code execution unit 5 fails in executing the code, the user evaluation unit 10 decides whether to perform the regeneration of the code by the code generation unit 4, to perform the regeneration of the code by the user himself/herself, to change an instruction sentence to be input via the input unit 2, or to give up regenerating the code. Alternatively, the user evaluation unit 10 may lastly evaluate the code executed by the code execution unit 5 on the basis of at least one of an execution time of the code and a memory use amount at the time of execution of the code.

The output unit 11 outputs at least one of the evaluation result of the execution result evaluation unit 6, the code generated by the code generation unit 4, or an evaluation result of the user evaluation unit 10. The processing of at least one of the n input unit 2, the prompt generation unit 3, the code generation unit 4, the code execution unit 5, the execution result evaluation unit 6, the execution result database 7, the prompt storage unit 8, the prompt correction unit 9, the user evaluation unit 10, and the output unit 11 may be executed by processing circuitry. The processing circuitry may be configured by, for example, a processor, a computer, or the like.

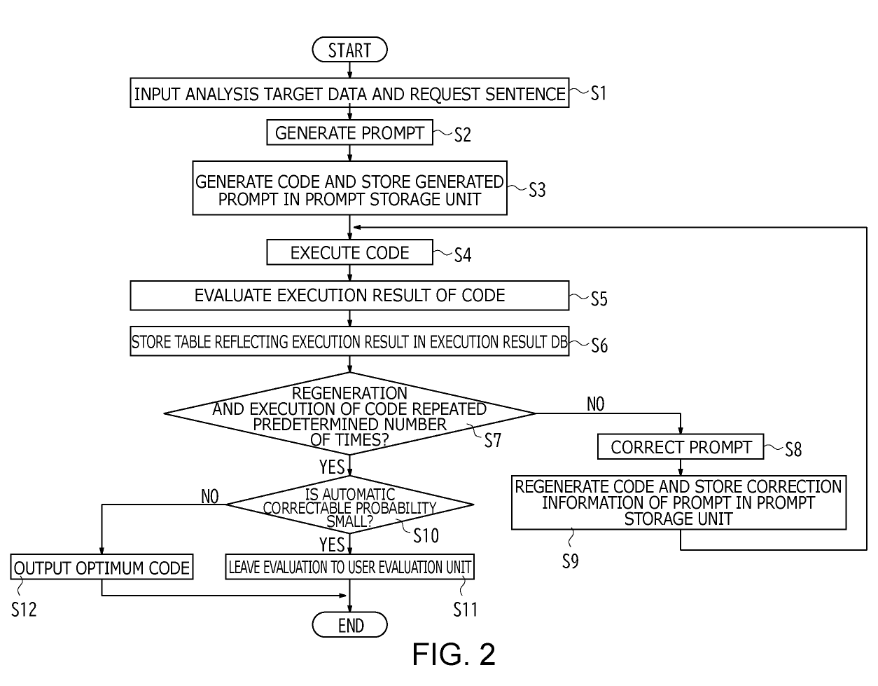

FIG. 2 is a flowchart illustrating processing operation of the information processing device 1 according to the embodiment. First, the analysis target data and the request sentence are input via the input unit 2 (step S1).

Next, the prompt generation unit 3 generates a prompt on the basis of the analysis target data and the request sentence (step S2). The prompt is an instruction sentence for code generation, and includes a file path and a file name in each which an explanatory variable and an objective variable are stored, a type of LLM to be used, a file path and a file name in which an LLM inference result is stored, and the like.

Next, the code generation unit 4 generates a code by using LLM on the basis of the prompt generated by the prompt generation unit 3, and the prompt storage unit 8 stores the prompt generated by the prompt generation unit 3 (step S3).

Next, the code execution unit 5 executes the code generated by the code generation unit 4 (step S4). The code execution unit 5 outputs an error message generated by execution of the code. A type of error message is arbitrary, for example, ModuleNotFoundError indicating that no software module exists, ValueError (NaN) that is generated when a missing value exists in the data, ValueError (Array shape) indicating that a size of an array is different, and the like.

Next, the execution result evaluation unit 6 evaluates an execution result of the code executed by the code execution unit 5 (step S5). For example, the execution result evaluation unit 6 generates a label on the basis of the error message generated by the execution of the code. The execution result evaluation unit 6 generates a table reflecting the execution result of the code and stores the table in the execution result DB 7 (step S6). The table includes, for example, information in which an error message, a label, the number of times of execution, and the number of times of successful correction are associated with each other for each error message.

Next, it is determined whether or not the regeneration and the execution of the code have been repeated the predetermined number of times (step S7). In a case where step S7 is NO, the prompt correction unit 9 corrects the prompt on the basis of the execution result of the code by the code execution unit 5 and the information stored in the execution result DB 7 (step S8).

Next, the code generation unit 4 regenerates a code on the basis of the prompt corrected by the prompt correction unit 9, and stores correction information of the prompt in the prompt storage unit 8 and the execution result DB 7 (step S9). Next, the processing is repeated from step S4 onward.

In a case where step S7 is YES, the execution result evaluation unit 6 determines whether the automatic correctable probability is small or not even when the regeneration of the code is repeated the predetermined number of times (step S10).

In a case where step S10 is YES, the execution result evaluation unit 6 leaves the evaluation to the user evaluation unit 10 (step S11). For example, the user evaluation unit 10 decides whether to regenerate a code by the code generation unit 4, to regenerate a code by the user himself/herself, to change the instruction sentence to be input via the input unit 2, or to give up regenerating a code.

In a case where step S10 is NO, the execution result evaluation unit 6 outputs an optimum code among the execution results stored in the execution result DB 7 via the output unit 11 (step S12).

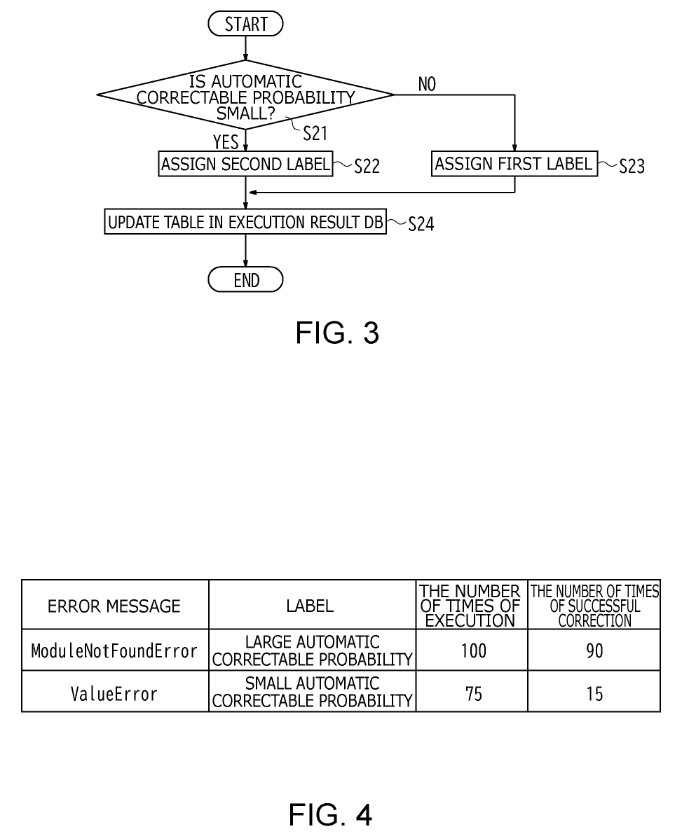

FIG. 3 is a detailed flowchart of the processing operation of step S5 in FIG. 2. The processing of the flowchart of FIG. 3 is performed by the execution result evaluation unit 6. First, on the basis of the error message output from the code execution unit 5, the execution result evaluation unit 6 determines whether or not the probability that the automatic correction of the code is possible is lower than the predetermined reference value (the automatic correctable probability is small) (step S21).

In a case where step S21 is YES, the execution result evaluation unit 6 assigns the second label (step S22). In a case where step S21 is NO, i.e., in a case where the automatic correctable probability is large, the execution result evaluation unit 6 assigns the first label (step S23).

When the processing of step S22 or S23 ends, the execution result evaluation unit 6 updates the table stored in the execution result DB 7 (step S24). When the processing of step S24 ends, the processing of step S6 of FIG. 2 is performed.

FIG. 4 is a diagram illustrating an example of a table stored in the execution result DB 7. As illustrated in FIG. 4, the table includes the information in which a type, a label, the number of times of execution, and the number of times of successful correction of an error message are associated with each other. FIG. 4 illustrates an example of an error message in a programming language called Python. In a case where codes of a plurality of different program languages are generated, separate tables are generated for the respective program languages and stored in the execution result DB 7.

As described above, the information processing device 1 according to the present embodiment can improve the quality of the code by repeating the regeneration of the code even when the code is successfully executed. In this case, the prompt correction unit 9 corrects the prompt with reference to the number of times of execution and the number of times of successful correction stored in the table of the execution result DB 7.

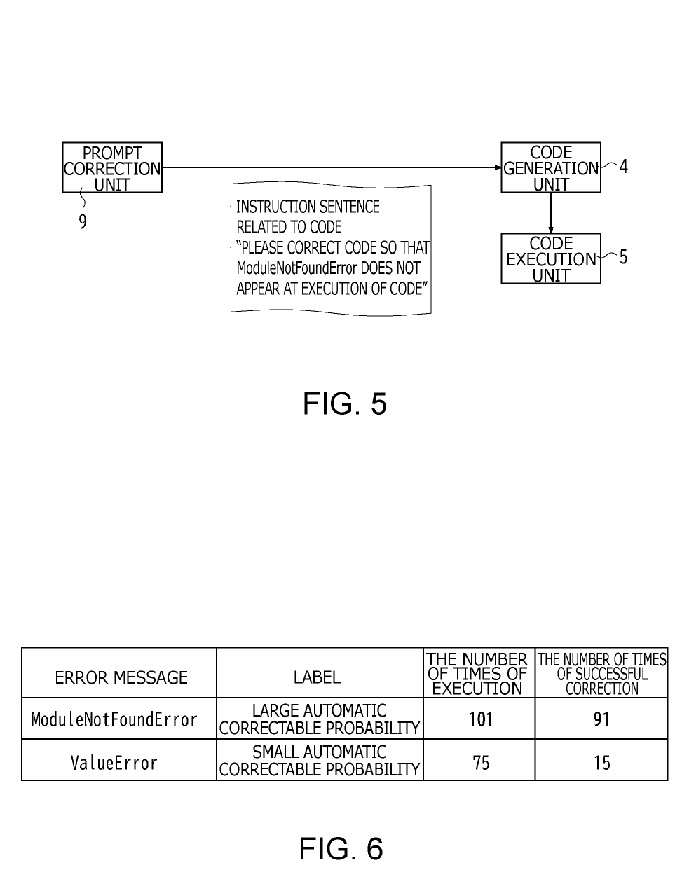

FIG. 5 is a diagram illustrating an example of a prompt corrected by the prompt correction unit 9. As illustrated in FIG. 5, the prompt corrected by the prompt correction unit 9 can include an instruction sentence related to a code and a caution for resolving an error message. FIG. 5 illustrates an example including a caution that “Please correct the code so that a specific error message (e.g., ModuleNotFoundError) does not appear at the time of execution of the code”.

In a case where the above-described caution is included in the prompt corrected by the prompt correction unit 9, the code generation unit 4 regenerates a code so that the error message specified by the caution is not generated.

FIG. 6 is a diagram illustrating update contents of the table in a case where the code is regenerated on the basis of the corrected prompt in FIG. 5. The table of FIG. 6 illustrates an example of update information in a case where the code regenerated on the basis of the corrected prompt of FIG. 5 is executed and the execution succeeds. Compared with FIG. 4, each of the number of times of execution and the number of times of successful correction of the line of the error message “ModuleNotFoundError” increases by one.

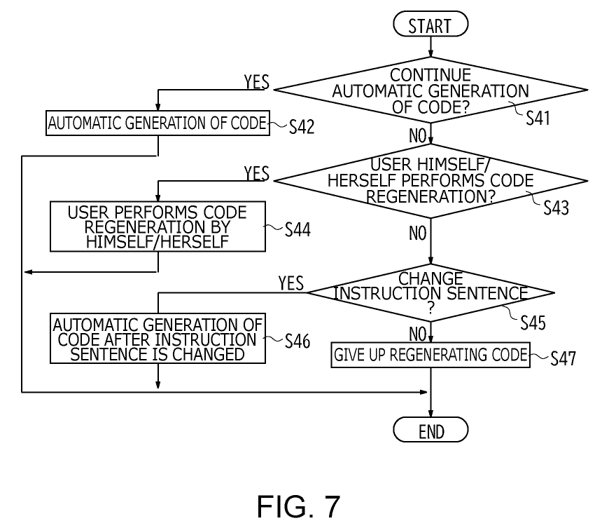

FIG. 7 is a flowchart illustrating the processing operation of the user evaluation unit 10. The execution result evaluation unit 6 leaves the evaluation to the user evaluation unit 10 in a case where the code is not successfully executed and the automatic correctable probability does not become large even when the regeneration of the code is repeated the predetermined number of times in a state where the automatic correctable probability is determined to be small.

First, the user evaluation unit 10 determines whether or not to continue automatic generation of a code (step S41). In a case where step S41 is YES, automatic generation processing of a code is continued, the automatic generation processing including the correction of the prompt by the prompt correction unit 9, the regeneration of the code in the code generation unit 4 using the corrected prompt, the execution of the code by the code execution unit 5, and the evaluation of the execution result by the execution result evaluation unit 6 (step S42).

In a case where step S41 is NO, it is determined whether to regenerate the code by the user himself/herself or not (step S43). In a case where step S43 is YES, the user manually regenerates the code by himself/herself (step S44).

In a case where step S43 is NO, it is determined whether to change the instruction sentence to be input via the input unit 2 or not(step S45). In a case where step S45 is YES, after the instruction sentence is changed, automatic generation processing of a code by the instruction sentence change is performed, the automatic generation processing including the processing of each of the prompt generation unit 3, the code generation unit 4, the code execution unit 5, the execution result evaluation unit 6, and the prompt correction unit 9 (step S46).

In a case where step S45 is NO, the regeneration of the code is given up (step S47).

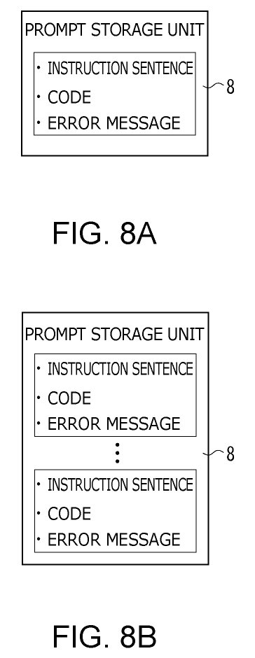

FIGS. 8A and 8B are diagrams illustrating information stored in the prompt storage unit 8. FIG. 8A illustrates an example in which the prompt related information is stored in the prompt storage unit 8 in an overwrite manner. As illustrated in FIG. 8A, the prompt related information includes, for example, an instruction sentence included in a prompt, a code generated by the code generation unit 4, and an error message generated at the time of execution of the code. In the case of the overwrite manner, every time the code execution unit 5 executes the code regenerated by the code generation unit 4, the prompt related information stored in the prompt storage unit 8 is overwritten.

FIG. 8B illustrates an example in which the prompt related information is stored in the prompt storage unit 8 in a history holding manner. As illustrated in FIG. 8B, in the history holding manner, every time the code execution unit 5 executes the code regenerated by the code generation unit 4, the prompt storage unit 8 stores new prompt related information while leaving past prompt related information. In this case, the prompt correction unit 9 may correct the prompt with reference to a past history of the prompt related information.

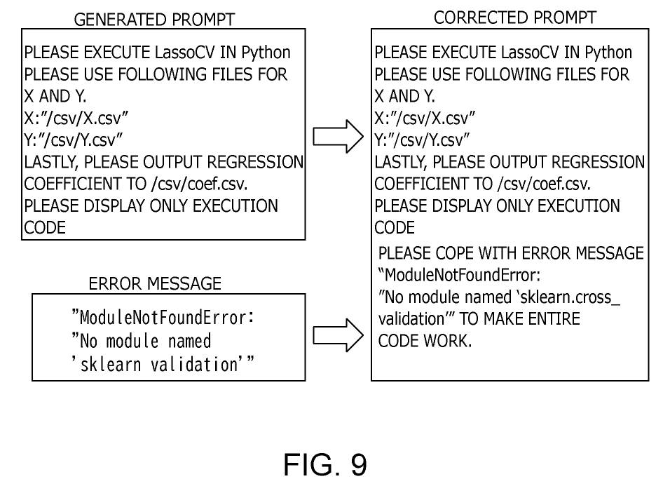

FIG. 9 is a diagram illustrating an example of the prompt related information stored in the prompt storage unit 8, the error message output from the execution result evaluation unit 6, and the prompt corrected by the prompt correction unit 9 when the code generation unit 4 uses LLM.

FIG. 9 illustrates an example in which in the prompt storage unit 8 before correcting a prompt, a prompt is stored which includes an instruction sentence “Please execute LassoCV in Python”, a file path and a file name “/csv/X.csv” of an explanatory variable X, a file path and a file name “./csv/y.csv” of an objective variable Y, a file path and a file name “./csv/coef.csv” in which an operated regression coefficient is recorded, and an instruction sentence “Please display only an execution code”.

FIG. 9 illustrates an example in which an error message “ModuleNotFoundError: No module named ‘sklearn.cross_validation’” is generated when the code generated on the basis of the prompt stored in the prompt storage unit 8 is executed. In this case, illustrated is an example in which the prompt correction unit 9 adds an instruction sentence “Please cope with the error statement “ModuleFoundNotError: No module named ‘sklearn.cross_validation’” to make the entire code work” in addition to the prompt stored in the prompt storage unit 8.

As described above, in the present embodiment, since the execution result DB 7 that stores the execution result information including a label and an error message is provided, when execution of a code fails, it is possible to quickly generate a code that can be successfully executed by referring to the execution result information. In addition, since a prompt is corrected with reference to the execution result information, it is possible to generate a prompt including an instruction sentence that prevents generation of a specific error message. Therefore, it is possible to prevent a problem that the same error message is generated many times when a regenerated code is executed. In addition, even when the regeneration of the code is repeated the predetermined number of times, in a case where the label as the small automatic correctable probability is included in the execution result information, evaluation is left to the user evaluation unit 10, so that it is not necessary to wastefully repeat the code regeneration, and it is possible to generate a code according to a user’s intention. In this manner, the execution result information stored in the execution result DB 7 can be used to correct a prompt and evaluate an execution result.

At least a part of the information processing device described in the above-described embodiment may be configured by hardware or software. In a case where the information processing device is configured by software, a program for implementing at least a part of functions of the information processing device may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, the program for implementing at least a part of the functions of the information processing device may be distributed via a communication line (including wireless communication) such as the Internet. Furthermore, the program may be distributed via a wired line or a wireless line such as the Internet or may be distributed while being stored in a recording medium in an encrypted, modulated, or compressed state.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. An information processing device comprising processing circuitry configured to:
input analysis target data and a request sentence;
generate a prompt based on the analysis target data and the request sentence;
generate a code based on the prompt;
execute the generated code;
evaluate an execution result of the generated code to generate a label;
store in a first storage, execution result information including the label and an error message generated when executing the generated code;
store in a second storage, prompt related information including the generated prompt, the executed code, and the error message;
correct the generated prompt based on the execution result information and the prompt related information;
evaluate the executed code based on an evaluation result of the execution result; and
output at least one of the evaluation result of the execution result or an evaluation result of the executed code, wherein
the processing circuitry is configured to regenerate a code based on the corrected prompt.

2. The information processing device according to claim 1, wherein
the processing circuitry is configured to input the prompt to a large language model (LLM) and to output the code inferred.

3. The information processing device according to claim 1, wherein
the processing circuitry is configured to generate the label according to a probability that automatic correction of the code is possible based on contents of the error message.

4. The information processing device according to claim 3, wherein
when it is determined that the probability that the automatic correction is possible is lower than a predetermined reference value based on the label included in the execution result information, the processing circuitry is configured to repeat regeneration of the code a predetermined number of times until the code is successfully executed or the probability that the automatic correction is possible becomes higher than the predetermined reference value.

5. The information processing device according to claim 3, wherein
the processing circuitry is configured to repeat regeneration of the code a predetermined number of times regardless of whether or not the probability that the automatic correction of the code is possible is high and whether or not the code is successfully executed.

6. The information processing device according to claim 3, wherein
when it is determined that the probability that the automatic correction is possible is lower than a predetermined reference value based on the label included in the execution result information, the processing circuitry is configured to generate a new prompt without referring to the prompt included in the prompt related information.

7. The information processing device according to claim 3, wherein
in a case where it is determined that the probability that the automatic correction is possible is lower than a predetermined reference value based on the label included in the execution result information even when repeating regeneration of the code a predetermined number of times, or in a case of failing in executing the code, the processing circuitry is configured to decide whether to perform regeneration of the code, to perform regeneration of the code by a user, to change an instruction sentence included in the prompt, or to give up regenerating the code.

8. The information processing device according to claim 3, wherein
when it is determined that the probability that the automatic correction is possible is higher than the predetermined reference value based on the label included in the execution result information, the processing circuitry is configured to correct a prompt based on an original prompt and the error message.

9. The information processing device according to claim 1, wherein
the processing circuitry is configured to correct a prompt so as to include an instruction sentence instructing to resolve the error message generated when executing the code.

10. The information processing device according to claim 1, wherein
the processing circuitry is configured to assign the label varying according to a type of the error message generated when executing the code.

11. The information processing device according to claim 1, wherein
the first storage has a table in which a type name of the error message, the label, a number of times of execution of the code, and a number of times of successful correction of a corrected code are associated with each other.

12. The information processing device according to claim 11, wherein
the first storage has the table for each type of LLM used to generate the code or for each program language that generates the code.

13. The information processing device according to claim 11, wherein
the processing circuitry is configured to update the label based on the table.

14. The information processing device according to claim 13, wherein
the processing circuitry is configured to update the label based on a ratio of the number of times of execution and the number of times of successful correction in the table.

15. The information processing device according to claim 1, wherein
the first storage stores unique information that affects quality of a code, and
the processing circuitry is configured to correct a prompt based on the unique information.

16. The information processing device according to claim 15, wherein
the unique information includes at least one of user's preference or coding rules.

17. The information processing device according to claim 1, wherein
the processing circuitry is configured to evaluate the executed code based on at least one of an execution time of the code or a memory use amount at the time of execution of the code.

18. The information processing device according to claim 1, wherein
the second storage overwrites the prompt related information each time an execution result of a code is newly evaluated.

19. The information processing device according to claim 1, wherein
each time an execution result of a code is newly evaluated, the second storage stores new prompt related information while leaving history information of past one of the prompt related information, and
the processing circuitry is configured to correct the prompt based on a code newly executed, the error message, and the history information stored in the second storage.

20. An information processing method comprising:
inputting analysis target data and a request sentence;
generating a prompt based on the analysis target data and the request sentence;
generating a code based on the prompt;
executing the generated code;
evaluating an execution result of the code and generating a label;
storing execution result information including the label and an error message generated at the time of execution of the code;
storing prompt related information including the generated prompt, the executed code, and the error message;
correcting the generated prompt based on the execution result information and the prompt related information;
evaluating the executed code based on an evaluation result of the execution result;
outputting at least one of the evaluation result of the execution result or an evaluation result of the executed code, and
regenerating a code based on the corrected prompt.
